(19) United States
(12) Patent Application Publication
(10) Pub. No.: US 2014/0278925 A1
(43) Pub. Date: Sep. 18, 2014

(54) System for Managing and Communicating Item Information

(71) Applicant: Shopchat Ltd., Windsor (GB)

(72) Inventors: Douglas Orr, Windsor (GB); Phil Payne, Norwich (GB)

(73) Assignee: Shopchat Ltd., Windsor (GB)

(21) Appl. No.: 13/804,768

(22) Filed: Mar. 14, 2013

(51) Int. Cl. G06Q 30/02

(52) U.S. Cl. CPC G06Q 30/0267
USPC 705/14.45; 705/14.64

(57) ABSTRACT

A method of communicating information relating to product or service offerings between a server system and client devices is disclosed. The method comprises storing in a database at the server system a plurality of data objects, each data object comprising information relating to a product or service offering. The data objects are associated with corresponding data objects stored at client devices. Information specifying an action relating to a selected data object is received. Based on information in the database, one or more descendant data objects associated with the selected data object are identified, the descendant data object having been derived from the selected data object, and information specifying the action is transmitted to a client device associated with each identified descendant data object, to enable the action to be implemented at the client device.

### BACKGROUND

1. Field of the Invention

The present invention relates to a communications system for exchanging information about items or topics of interest, such as products and other commercial offerings.

2. Description of Related Art

Mobile advertising is currently in its infancy. It can be compared to early TV advertising of the 50s with static images and voice-overs which did not take advantage of visual possibilities of the television medium. Likewise today, mobile advertising usually does not take advantage of the rich information available from a mobile telephone device or its intimate relationship with its owner. Most mobile advertising today is modelled on online banner advertisements or full-screen advertisements that have been squeezed onto a relatively small mobile device screen.

### SUMMARY

Though mobile devices may include a wide range of communications functionality, including SMS/MMS messaging, email and web access, these are generally not well integrated, and effective communication relating to a topic of interest, where such communication might include referencing of external information sources, can be awkward and cumbersome. For example, a user may view a topic of interest on a web page and then copy the URL, switch to a messaging application, and paste the copied URL into a message for transmission to another user. However, such a process is difficult and error-prone, and does not lend itself to effective spontaneous communication. Also, there is no way of tracking such ad hoc communications, and if the recipient eventually visits the URL (and possibly makes a purchase), the referral history, which could provide valuable marketing information, is usually lost.

The present invention seeks to alleviate some of these problems.

Accordingly, in a first aspect of the invention, there is provided a method of communicating information relating to product or service offerings between a server system and client devices, the method comprising, at the server system: storing in a database a plurality of data objects, each data object comprising information relating to a product or service offering; wherein the data objects are preferably associated with corresponding data objects stored at client devices; receiving information specifying an action relating to a selected data object; identifying based on information in the database one or more descendant data objects associated with the selected data object, the descendant data object having been derived from the selected data object; and transmitting information specifying the action to a client device associated with each identified descendant data object.

This approach allows actions relating to a data object to be propagated automatically to descendant data objects held at user devices. This functionality in turn enables free exchange and modification of data objects by system users, without losing the ability to effect changes or implement other actions across different versions of a data object that may be in use on different user devices.

The term “data object” as used herein preferably refers to a data package that includes information relating to a product or service offering. Alternatively, the data object could include information relating to some other topic of interest (not necessarily a product or service offering). Thus, the methods and systems disclosed herein can be extended to applications other than managing and exchanging product/service information, to provide corresponding methods and systems for managing and exchanging other types of information.

The data object or package can include different types of information, such as images, video, audio or other media information, text information, numerical information, location information, time information (e.g. timestamps), URLs, and any other types of information that may be relevant. The various different data elements are preferably packaged into a single data package or entity that can be stored, transmitted, and received as a single unit. Though a data object may be implemented as an object in an object-oriented environment or database, the term “object” is not intended to be restricted in this way, and a data object may be implemented using any other suitable data structures and data storage technologies (including relational databases and other non-object-oriented technologies). Data objects are also referred to in the detailed description below as “Items”. Terms such as “descendant data object” or “derived data object” as used herein preferably refer to a data object that was created from another (parent) data object, for example as a copy or modified copy of the parent data object. Descendant data objects may be created, for example, by users/at user devices, for example by modifying existing data objects, or sharing data objects with (transmitting data objects to) other users/user devices.

The identified descendant data object may be stored in the database, at a client device, or both.

The method preferably further comprises performing the specified action in relation to an identified descendant data object at the associated user device.

The action may comprise a modification to the data object. The transmitted information then preferably specifies the modification. This can allow modifications of a data object to be propagated to multiple descendants of the data object held at different user devices, for example to keep the descendant data objects consistent with the original parent data object. The method thus preferably further comprises modifying a descendant data object at the client device in accordance with the transmitted information. Descendant data objects may include one or more elements that can be modified in this way (essentially through inheritance of parent object modifications) and these elements may not be modifiable by users. Descendant data elements may further include one or more other elements that are specific to the descendant data objects and these may be modifiable by users.

A modification could, for example, relate to a change in a product/service description, or pricing or availability information for the product/service. A modification can encompass any other type of change to a data object, including deletion.

Alternatively or in addition, the action may comprises addition of information to a data object, the information preferably specifying an offer or promotion relating to the product or service offering represented by the data object. This could, for example, be a special offer or voucher that the user can make use of when purchasing the product/service offering. This feature can allow promotions to be distributed to users interested in a product/service, even where users have modified or customised the original data object. Such information may be provided in the form of a notification that may be displayed to users on their devices.

The method may further comprise identifying a user associated with an identified descendant data object, wherein the information is transmitted to one or more user devices associated with the identified user. The database may specify users (or user devices) associated with data objects or descendant data objects (for example, users/user devices that created a data object or currently store a copy of the data object).

The database preferably specifies derivation relationships between data objects, a derivation relationship indicating that a given data object has been derived from another data object, wherein the identifying is performed based on the derivation relationships. The database thus retains links between a data object and its associated descendant objects, allowing the evolution and spread of data objects to be tracked and analysed, and actions to be propagated to descendants.

Preferably, an identified descendant data object is associated (e.g. in the database) with a user having created the descendant data object based on the selected data object, and the information is preferably transmitted to the associated user. Thus, a user who creates a customised version of a data object can still receive information relevant to the original data object, such as a modification or promotional offer.

The method preferably comprises receiving copies of data objects stored at client devices, and storing the copies of data objects in the database. This allows tracking of data objects in the system whilst also enabling backup functionality. Unless otherwise required by context, references to data objects herein generally refer also to descendant (derived) data objects.

The method preferably comprises receiving derivation information from a client device specifying that a received data object was derived from a further data object, the derived data object created at the client device, and recording a derivation relationship in the database between the received data object and the further data object.

The method may further comprise analysing data objects and derivation relationships between data objects, preferably to determine information indicative of evolution and/or spread of data objects and their associated descendant data objects amongst a community of system users.

A data object comprising information relating to a product or service offering may include one or more of: image or video information relating to the product or service offering; text information relating to the product or service offering; information specifying a source or availability of the product or service offering; price information relating to the product or service offering; location information relating to the product or service offering (e.g. a location where the product/service is available or was seen by the user creating the data object); and time information relating to the data object or product or service offering, for example specifying a creation time of the data object, validity time of an offer, or the like.

The invention also provides a computer readable medium comprising software code for execution on a data processing apparatus, the software code adapted to execute a method as set out above, and a system or apparatus comprising a processor and associated memory, or other means, configured to carry out a method as set out above.

In a further aspect of the invention (which may be combined with any previous or subsequently described aspects), there is provided a tangible (physically embodied) computer-readable medium comprising a software application for a client device adapted to communicate with a remote server system, the software application configured, when executed on the client device, to perform the steps of: providing access to a plurality of data objects, each data object comprising information relating to a product or service offering; receiving a modification relating to a selected first one of the plurality of data objects; and, in response to the received modification: creating a second (derived or descendant) data object based on the selected first data object and the received modification; associating derivation information with at least one of the first and second data objects indicating that the second data object was derived from the first data object; and transmitting the second data object preferably with the derivation information to the remote server system.

This can enable modifications to data objects to be tracked effectively by a central system.

The software application is preferably configured to store the plurality of data objects in a database at the client device, and may optionally transmit copies of stored data objects to the server system (e.g. to enable tracking and/or backup).

The derivation information may include a reference to the first data object, the reference contained in the second data object (in other words, the relationship may be encoded within the descendant data object, e.g. by way of an identifier identifying the parent data object).

The software application is preferably further configured to: receive information specifying an action or modification relating to a selected one of the data objects from the server system; and apply the action or modification to the selected data object. The selected data object may, for example, be a descendant data object of another data object.

The application is preferably further configured to provide a user interface for at least one of: creating or modifying data objects; creating derived data objects based on provided/stored data objects; creating or modifying one or more lists of data objects; sharing (transmitting) data objects or lists with other users; and initiating a communication exchange (e.g. a text message exchange) with one or more users, the communication exchange associated with a selected data object. The application may implement several or all of the above functions.

The invention also provides independently a method corresponding to the method performed by the software application of the above aspect of the invention, and a system, apparatus or client device having a processor and associated memory, or other means, configured to perform such a method.

In a further aspect of the invention (which may be combined with any of the above aspects), there is provided a system for tracking exchange of information relating to product or service offerings between system users, comprising: a database module configured to store a plurality of data objects, each data object comprising information relating to a product or service offering; wherein the data objects are preferably associated with corresponding data objects stored at client devices; wherein the database module is configured, for a selected data object in the database, to store one or more descendant data objects of the selected data object in the database, the descendant data objects created based on the selected data object at one or more user devices, and to store information specifying derivation relationships, the derivation relationships specifying that the descendant data objects were derived from the selected data object; and wherein the system further comprises an analysis module adapted to analyse data objects and derivation relationships in the database.

This can enable valuable information to be obtained concerning evolution and spread of data objects amongst system users.

The data objects and/or descendant data objects are preferably associated with users or user devices storing copies of the data objects or having created the data objects. This allows activity to be tracked and analysed at the user level.

The analysis module is preferably adapted to perform at least one of: identifying, for a given data object, users (and/or user devices) associated with the given data object or with descendant data objects of the given data object; measuring or analysing the evolution and/or spread of a given data object and its associated descendant objects between system users (and/or associated user devices); and measuring or analysing user interactions relating to a given data object and its associated descendant data objects. Such analysis can enable valuable marketing information to be obtained, as well as enabling user-targeted follow-on promotional activities, marketing or offer provision.

The client devices are preferably configured to transmit information to the system, the information including at least one of: information relating to data objects created or stored at the client devices; and information relating to interactions with data objects at the client devices. Preferably, the client devices are configured to transmit user interaction information relating to data objects to the system based on one or more configurable or pre-configured user interaction triggers. These triggers may specify particular user interactions or types or classes of user interactions relating to data objects that should trigger the relevant user interaction to be reported to the system, and may be configured by the system, at the client device, or both.

The analysis module is preferably configured to analyse user interaction information relating to user interactions with one or more specified data objects and their associated descendant data objects. This can enable the system to obtain a comprehensive view of user behaviour relating to a particular data object and its descendants.

The system may be in the form of one or more server computers which are able to communicate with client or user devices over a network.

In further aspects, the invention also provides a corresponding method for performing the activities of the system aspect as defined above, and a computer-readable medium including software for performing such a method.

In a further aspect (which may be combined with any of the other aspects described), there is provided a method comprising: creating or receiving at least a data pack (or data object or item); keeping a list of the data packs; enabling annotation/modification of each of the data packs, thereby creating daughter (descendant) data packs; tracking the data packs and each of the daughter (descendant) data packs (e.g. as they are shared/transferred between users); and enabling the forwarding of a feature, action, event or modification relating to a data pack to each of its daughter (descendant) data packs. Corresponding system, apparatus, and computer-readable medium aspects may also be provided.

More generally, the invention provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

Any feature in one aspect of the invention may be applied to other aspects of the invention, in any appropriate combination. In particular, method aspects may be applied to apparatus aspects, and vice versa.

### BRIEF DESCRIPTION OF THE DRAWINGS

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:—

FIG. 1 illustrates a product information exchange system in overview;

FIG. 2 illustrates some components and processes forming part of the product information exchange system;

FIG. 3 illustrates a method for propagating update events;

FIGS. 4A and 4B are screenshots of a user application;

FIG. 5 illustrates data structures used in an implementation of the system;

FIG. 6 provides an overview of a system architecture for the system; and

FIG. 7 illustrates communication flow between user devices and a central server.

### DETAILED DESCRIPTION

### System Overview

Embodiments of the invention provide a system for exchange and tracking of information relating to topics of interest, in particular products and other commercial offerings, between users of a communications network. Such a system is shown in overview in FIG. 1.

As illustrated in FIG. 1, a plurality of user devices 102, 104, 106 may communicate with each other via a communications network, 108. The user devices may be mobile communications devices, such as smartphones or tablet computers. In preferred embodiments, the user devices include an application (e.g. a smartphone app) which enables participation in the information exchange system. Instead of an application, a web interface could be provided.

The communications network may be a heterogeneous network, including, for example, mobile telephony networks, wired and wireless local area networks, and wide-area networks, such as the Internet.

The user devices have access to a variety of information sources, such as websites 112, 114 and 116 via the network 108, to obtain information on topics of interests, such as products or services available for purchase or other commercial offerings. The user devices further have access to a discussion server 110 which facilitates exchange of information between user devices concerning the topics of interest, as well as providing curated information of interest to users. The user application running on the user devices and the discussion server are typically provided by a service operator.

In the following description, the system will be described in particular in relation to products available for sale through online outlets (websites) or offline (physical) outlets, where products may include purchasable items, service offerings, and the like. However, it will be understood that the system can be used to manage and exchange information on any suitable information topics, not just products of the above kind.

FIG. 2 illustrates the product information exchange system in more detail.

In the described system, information on products is managed, exchanged, and tracked in the form of “Items”. An Item is a unit of product information, including descriptive information (e.g. text and images), product attributes such as price, information on the source of the product (e.g. online/offline retailer physical and/or web addresses) and any other information that may be relevant to the product. The Item may include a URL referencing an Internet location where the product can be purchased.

An item may include information (e.g. notes) added by a user, along with information provided by the creator of the item (e.g. the service operator, a retailer, or another user).

As shown in FIG. 2, a user device 202 may include a plurality of stored items 204. These are stored in local storage at the device. An Item is in the form of a data package including the relevant product information, and items are communicated, stored and managed by the system in the form of such data packages (where the data packages can be implemented using any suitable data structures).

In addition, the user device stores user-defined lists 206, where a list is a list of Items. For example, a list may represent a list of related products a user is interested in, a shopping list of products a user is planning on purchasing, a wish list of products a user would like to own or receive as gifts, or any other grouping of products. The user can create lists from stored items 204 by adding the relevant items to a list, and can share lists with other users (e.g. user device 210).

A user can additionally initiate a “chat” discussion about one of their stored items by selecting an item from their stored items and identifying one or more users with whom they wish to conduct a chat about the item. Though for clarity a direct connection between user devices is shown in FIG. 2, such chats and other user-user interaction preferably occur via the discussion server 212. The discussion server may maintain friends lists for each user identifying other users they are able to communicate with on the system, and the discussion server also routes chat communications and other user-user interactions between the relevant user devices. Users can find other users on the system to add to their friends list by exchanging suitable identifying information, such as a user ID, telephone number or email address that uniquely identifies the user in the system.

Once the chat has been initiated, a copy of the Item to which the chat relates is transferred to the other participating user(s) and stored in those users' stored items to allow those users subsequently to view the item or interact with it in any way (including modifying the item as discussed in more detail below). Once in progress, a chat proceeds in a similar manner to an instant messaging conversation, though the participating users may at any point add further Items to the chat, which are then again transmitted to the other participant(s).

A user may create new items in their stored items 204 by obtaining information relating to a product from web sources 220. To support this, the user application running on the user device provides an integrated web browser (or integration of an external browser), allowing the user to access a product page on a web site and copy relevant information, such as a product image. After selecting an image on the target page, the application adds the image and the web page URL to the new Item, and provides the user the option of entering additional information such as price and text notes relating to the product. This information is added to the Item, which is stored in Stored Items 204.

The application preferably also allows items to be created in other ways, for example by simply entering information directly without accessing an external web source. Images may be obtained directly from a camera integrated into the user device. This may be suitable, for example, for an item that a user has found at an offline retailer. Location information may also be added (e.g. based on GPS or other location information available in the user device).

Furthermore, items may be obtained from a curated catalogue of items 214 stored on the discussion server 212. These curated items may, for example, have been created by the service operator or by retailers or brands partnering with the service operator. Curated lists 216 may also be provided and accessed in a similar way.

By accessing the curated item catalogue (e.g. via a suitable browsing interface in the user application) or curated lists, the user can discover new items, which they can copy to their device and store in their stored items 204. They can then use these items in the same way as user-created items, such as by modifying them, adding them to lists (which can be shared with other users) or starting chats with other users.

Copies of the user's stored items (whether created by the user directly, or obtained from another user or from the curated content and then possibly modified) are transmitted to the discussion server 212, for example in response to creation/modification or at regular intervals. This provides a backup function, allowing the user's content to be restored if the user device is replaced or content is deleted.

Furthermore, copying of user items to the server also enables tracking and analysis by the service operator of the Items and associated user behaviour. For example, the discussion server 212 can track the spread of particular items as they are shared between users, and can analyse how items are used and modified by users. The discussion server can also push information related to items to users. These functions are described in more detail below.

Users' lists, chat histories, and any other relevant information may also be copied to the server in a similar manner.

### User Application

In this embodiment, the user application is in the form of a smartphone or tablet app, though other types of standalone applications or web-based applications/interfaces could be provided depending on platform.

FIGS. 4A and 4B show sample screenshots of the user application.

FIG. 4A illustrates an interface for adding a new item. This includes an image of the item 402 (obtained, e.g. from a web source or the device camera). A series of tabs 404 allow addition and modification of item information. Here four tabs are shown for editing image/video content, item description, price information and location information (which could be entered manually or obtained through GPS or other location services). Other classes of information could be added as required.

The currently active tab 406 relates to the item description and allows text entry of an item name and related notes.

The chat interface is illustrated in FIG. 4B. Here, a user “Douglas” has started a chat concerning a particular item “Hooks”. A heading panel 408 of the interface identifies the user and item by displaying an image associated with the item. A chat panel 410 displays messages exchanged between the users participating in the chat, and provides interface features 412 for typing and sending a new message, adding emoticons and adding new items to the chat (button 414).

A main button interface 416 is also shown which is common to all interface screens (though currently covered up by the keypad in FIG. 4A) and provides for navigation to the application's main sections. These include a “Home” screen (which lists the user's Items and provides information on incoming activity, e.g. chat/friend requests); a “Chat” section (currently active); a “Lists” section for managing lists; and a “Friends” section for managing the user's friends list. An “add” button 418 is also provided to enable the user to create a new item from anywhere within the interface.

### Further Details Concerning Items

In preferred embodiments, Items are designed specifically with mobile usage in mind and address some of the opportunities of mobile advertising.

The “Item” is the base unit of information to inform a user about a product/service offering. Both users and retailers/brands can create Items. Items are similar in structure in either case. Users can modify Items which can then become part of a new chat. In either case, the Item is a personal recommendation by one user of the system to another. Given that personal recommendation is generally considered a particularly powerful form of advertising this can provide an effective opportunity to promote products and services. The Item can also use location information to modify the information contained in the Item such as location and voucher/coupon offering.

The Item is a unit of information from which all conversations begin. At its core it is a description of a product or service. This description may include any suitable information. For example, an item may include one or more of the following:

Main Image

Additional Images

Video Clip/Link

Title

Price

Voucher/Coupon Information

Online Location—where available

Physical Location—where available

Comments from Retailer/Brand

Comments from other system users

User rating & comments on product

Creation time stamp on Item so that users can judge how current an offering is.

Items may also include interaction history information, specifying the types of interactions that took place and possibly time and/or location information relating to the interactions.

Items may originate either from a Retailer/Brand, or from a user of a system who may create an Item via online search, using an existing photo or taking a new photo. The Retailer/Brand may have access to tools in the system to extend the content of an Item beyond that which users can create.

### Creating Derived Items

A user may modify an Item obtained from another source (e.g. another user, a retailer, the discussion server, etc.). This results in the creation of a derived or descendant item (terms such as “derived item”, “descendant item”, and “child item” are generally used interchangeably herein). While different from the original item, the system maintains an association between the derived item and the original item. Furthermore, since any items created by the user (including derived items) are copied from the user device to the discussion server, the system can track the changes made to the item, and identify all derived items corresponding to particular original items, as well as identifying the users who created, or have copies of, those derived items (e.g. through sharing between users).

Certain other activities within the user device application, such as copying an item, moving an item from one list to another, or giving an item a new name, may also create new derived items.

Derived items may also be created based on other derived items.

The ability to manage multiple derived versions of items whilst retaining their association with the original (parent) item is referred to herein as item polymorphism.

Which information users can modify or add when creating derived items may depend on the type of item and/or its creator (for example, user-created items may be freely edited but modification of retailer-created items may be limited to certain fields).

In a particular example, users can modify comments fields for all Items, and fill in empty fields of Items created by other users but not those of retailers/brands. For those Items created by retailers and brands users may additionally be prevented from modifying:

Images

Video Links

Title

Price

Voucher/Coupon Information

Comments from Retailers/Brand

Location information

### Tracking and Backup of Polymorphic (Derived) Items

As users modify an Item (e.g. as part of a new chat or to save as a modified Item to their own lists) the modification results in a new version of the Item. This is tracked by the server both as a separate item and as a “child” item of the original “parent” item. The modification takes place on the user's device but the item is backed up and tracked by the server.

The system operator is then able to follow and report on these changes to an original item. For example, the system can track the spread of an original item (irrespective of changes made to it). This is achieved by identifying all copies of the original item and any derived child items of the original item in the users' item inventories. The system can then further identify the users holding such items in their inventories, and can also collect information on how the items have been used.

This tracking and analysis capability (which may be implemented using an analysis module provided at the server or externally) enables the measurement of useful marketing information, such as virality (e.g. how far and/or fast an item spreads in either original or derived form). It further enables targeted marketing activities (e.g. by analysis of user preferences and behaviours or by identifying users interested in particular products or classes of products).

Furthermore, tracking and analysis also enables monetisation of usage of the system. For example, the service operator may charge participating retailers for participation in the service based on the popularity or levels of activity relating to their Items (for example, measured in terms of the spread of the original or associated derived Items amongst users).

### Propagating Modifications and Other Information Relating to Items

As described above, the present system maintains associations between derived items and the original items, and copies of all items (original and derived) are held at the discussion server. The server thus in effect maintains an inheritance hierarchy of original and derived items as created and used by all of the system's users. The information stored at the server for an item includes information identifying the user associated with that item.

This enables the system to identify, for a given item, all the users storing a derived item based on the given item. This in turn allows the system to propagate actions, events or changes relating to an item to each user who holds a copy of the item or a derived item that based on the item.

For example, a retailer may change information relating to an original item, such as an associated image, product description, or price information. The system then identifies all derived items derived from the original item, and the users associated with those items (i.e. who created or hold stored copies of those items). The system than transmits the modifications to each identified user. On receiving the information, the application at each user's user device then modifies the (derived) item accordingly. In this way, modifications to the original items can be propagated to all of its child (derived) items.

A modification could also involve adding information to an item (for example information specifying a special offer or voucher relating to the product), which would then appear in the associated derived items at each user's device using the described propagation mechanism.

As a further example, a modification could involve deletion of the original item. Propagation of this event could involve deletion of all associated child events.

Any other type of modification, event or action can be propagated using the described approach. Propagation could affect all derived items, or alternatively only selected ones based on some predetermined criterion.

The process is summarised in FIG. 3.

In step 302, the system (e.g. the discussion server 212 if FIG. 2), receives information specifying a modification, action or event relating to a particular original Item. This information may, for example, be received from the item creator, such as a retailer.

In step 304, the system identifies copies of the original Item or derived Items that were created based on the original Item, using the server copy of user information (e.g. server copy 218 in FIG. 2). The system may identify all relevant (derived) Items or only a subset, e.g. based on configured criteria.

In step 306, the system identifies the users (and/or user devices) associated with the identified (derived) Items.

In step 308, the system transmits information specifying the modification, action or event to the identified users (and/or associated user devices).

In step 310, the user application at the identified users' devices implements the specified modification, action or event for the relevant (derived) Items. This may involve updating the relevant (derived) Items in the locally stored Items (e.g. stored items 204 in FIG. 2) based on the received information.

### Implementation Details

The following section provides some additional details of a particular implementation of the above-described system. It will be understood that the principles described above can also be implemented in other ways using different data structures, algorithms and tools. In this embodiment, the system is referred to as the “ShopChat” system, and the user application running on the user device is referred to as the “ShopChat” application.

The ShopChat application in this implementation is an iOS or Android application which allows mobile device users to interact with their friends and associates and involve them in a virtual shopping experience. The ShopChat application can be installed to a device from an app store associated with the relevant platform.

As described previously, the system revolves around representations of products/offerings which are termed “Items”. A ShopChat Item is a data object which a ShopChat user can reference and/or provide electronic media and information for. It is the centre of the electronic interaction via ShopChat-enabled devices and users. Each “Item” has a single origin via a user or retailer, and may then be made available to other users, for example through a shared list of items (e.g. created by a user, retailer, brand, or celebrity user). Items may also be shared through chats between users using the built-in chat functionality of the system. After initial creation and sharing, the item spreads through the ShopChat ecosystem, each user adding to it or modifying it and thereby spawning descendant items.

Successive descendants retain a link to the original items such that it is possible to trace the origin and ancestors of any item. It is also possible for items to be combined into new composite items with two or more parents, and these composite items can themselves then propagate through the system.

As a result, a ShopChat Item has a life history which the ShopChat back-end system can manage and analyse, for example to reveal the Item's spread through the ShopChat user community, and the degree to which each user has interacted with it.

A Logical Data Structure relating to key elements of the system and illustrating item relationships is shown in FIG. 5.

FIG. 5 shows the core entities which surround the ShopChat “Item” and their relationships. Here, all relationships are one-to-many (the many end of the relationship being at the arrowhead end). Note the “list item” entity here implements a many-to-many relationship which would otherwise exist between “item” and “list”. The depicted data structures may be implemented, for example, using tables in a relational database, as objects in an object-oriented environment (or object-relational database), or in any other suitable way.

The information depicted is stored in a central database, as well as in user-specific databases on each user device, as described previously in relation to FIG. 2 (where stored items, lists and chats 204, 206, 208 are part of the client database, and copies of user information 218 are stored in the server database). This architecture is discussed in more detail below.

Each distinct item is identified in the database by a unique identifier. When a user modifies an original item, a descendant item is created as a new “Item” data object in the database, with a new identifier. The new Item includes a reference to the parent item in the form of the unique identifier of the parent item. This enables subsequent searching of the database to identify descendant items of any given item (if necessary the searching may be iterative to allow for multiple levels of dependency). The mapping between items and descendant items may be explicitly implemented (e.g. in a relational database via foreign key mappings) or may exploit features of an object-oriented database, in which descendant items may be modelled as OO-descendants of parent items to provide the required mapping implicitly.

Key software components of the system are illustrated in FIG. 6. The directed graph also shows the distribution of responsibility for the software components between implementation teams, highlighting the fact that the system is modularised in such a way as to allow separate development and maintenance of the back-end and front-end components. FIG. 6 also illustrates where the software components are located between the client (user device/user application), and the back-end system.

In this embodiment, the database is distributed across all connected devices so that data is always available to the client even when offline, with a strict synchronisation protocol used to keep the central database and the devices in line with one another. This architecture permits the client to update the server based on a local transaction queue when it has been offline and the server to populate new devices for pre-existing users. The backend database holds all data about all users and is kept as up-to-date as possible, while the clients have a local database specific to their user. This database may be replicated across multiple user devices associated with the user (e.g. multiple user devices registered to a single user account).

The present implementation envisages application support for iOS and Android user devices. In this embodiment, as shown, the front end applications are implemented as Objective C or Java applications. These interface with a local database component (here implemented in C++) and an interface to the central server (also implemented in C++). The server is referred to in this embodiment as the “ChatterHub” server. The server also includes the central database (server and database components are here both implemented in C++, running on a Linux platform).

However, any suitable user device platforms can in principle be supported (e.g. Windows or other desktop OS, or other mobile device platforms such as Windows Mobile or Windows RT). Other server platforms may also be used. Furthermore, the software components can be implemented using any suitable programming languages/environments. Though for clarity, a single central server shown, the server functionality may be distributed over multiple physical servers.

In this implementation, wire communication always occurs between the system level C++ components which are part of the backend system (and the responsibility of the system programmers). The front-end programming teams are provided with C++ modules which provide the device-local database and the communication library necessary to communicate with the server. This means that the backend system extends physically into every ShopChat device and the front-end developers are free to concentrate on interactivity and look-and-feel, whilst maintaining real-time response characteristics and offline capability.

### Communication Between Devices and Server

All communication between devices is orchestrated by the ChatterHub Server. Data packets associated with real time (chats) about an item are communicated first from a client to ChatterHub, and the ChatterHub then propagates the information to the other participating client(s), where the local database is updated accordingly.

From a user perspective it appears as though a chat is occurring directly with the devices of other involved users but ChatterHub is actually at the other end and no direct communication ever exists between the user devices in this implementation (alternative embodiments could provide for direct communication). At any given time ChatterHub is orchestrating a potentially very large number of chats in this manner and so an architecture and algorithms are provided that ensure that correct sessions and strict order are maintained.

Chat communication is illustrated in FIG. 7, which shows the actual message flow between various user devices participating in a chat, via the ChatterHub (as solid arrows), and the apparent chat flow between user devices as it appears to the users (dashed arrows).

The ShopChat system enables devices to deal gracefully with being offline by having available a device-local user-specific database and a queue for requests to the server which are to be processed when connectivity is restored.

The Chatterhub client-side library has a single interface which can communicate with either the server or with the client database. This interface is structured as a set of “Verbs” which centre around actions that are to be performed on items and/or the list or chat that is associated with or owns the item.

If real communication occurs with ChatterHub then the Verb is physically sent over the network; if connectivity has disappeared or changes apply locally only, then the library routes the request to the local high-speed database.

Often both the ChatterHub and the local database can safely be updated concurrently thereby automatically synchronising them. Most Verbs are synchronous and make dual changes, however some actions are only applicable to, or can only be performed by ChatterHub, and are therefore asynchronous. Typically, asynchronous Verbs cause ChatterHub to send emails, push notifications or set up invitations between users where they are offline (or with network users who are not yet ShopChat users).

ShopChat is a stateful system; whilst primarily supporting item centred real-time synchronous communication, it also provides batch facilities and asynchronous store-and-forward means of communication.

The ShopChat “Item” is the centre of gravity not only for the database but also its communication. In both cases the system design enables and encourages a very open means of interacting with products as social media. Once an item has come to the attention of a user it can be customised by them and/or combined with other items and then these descendants of the original item passed to other users in lists and chats. The ChatterHub Server and its database are constantly abreast of the evolution of every item through the global ShopChat community and therefore all commercially significant activity is captured in real-time by the database.

### Item Evolution, Inheritance and Polymorphism

The organic behaviour of the ShopChat “Item” is achieved through a combination of the object-oriented facilities of C++, the physical design of the system and the deliberately highly viral nature of the ShopChat system as a whole.

The System provides a wide variety of facilities to allow users to connect with one another and to permit existing ShopChat users to invite individuals who are not yet ShopChat users. Chats and lists centre around “Items” and if a user wishes to interact with anybody in their address book, Chatterhub will wait for that individual to either connect or sign up and will automatically involve them.

The distributed nature of the database, with its support for offline working and automatic synchronisation, allows items to evolve independently on network-isolated devices. The highly efficient wire protocol and design of internal data structures and algorithms produces real-time chat with any number of users and enables any participating user to add to the electronic item entity or indeed create a new related item which can then be shared with other users.

### Tracing Item Evolution and Usage

As previously described, the system enables the usage, spread, and evolution of items to be analysed and traced. For example, the system can determine which users have received and/or interacted with a particular item (whether in original form or as a modified descendant). As mentioned, this information, which is available from the central database, can allow valuable marketing information to be obtained, as well as providing source data on which to base monetisation of system use.

To further support this, the system preferably allows the configuration of trigger events surrounding an item which can be used to measure usage and/or trigger micro-payments in an analogous manner to web page banner click-throughs. Examples of trigger events that can be configured include:
Downloading of a list to a personal instance of ShopChat.
Sharing a list to/from one user to another user.
Opening an item on a list (every item-open event may be a commercially chargeable event).
Sharing an item (modified or not) with another user, optionally conditional on whether the destination user opens it.
Clicking through to a designated web page (e.g. a product source URL identified in the Item information)
Downloading a voucher/coupon/offer linked to an Item to the user device
User moving to a specific retail location such as a store within specified parameters such as time

Any type of user interaction with lists or items can in principle be detected using such trigger events, which can then in turn be used to measure and monetise usage by the back-end system. For example, the service operator may charge a retailer partner, who has added Items and/or Lists to the system, based on user interaction with those Items/Lists, as measured using the configured triggers. Which triggers are used and/or how the accounting is performed may vary between service partners. In addition to triggers, statistical analysis of data in the database may also be performed.

The above-described system provides a number of advantageous features, including:
The “Item” data object allows the combination of information about a product or service offering, user interaction, user location and time to be captured into an electronic entity
Items can be modified and produce descendant items; the evolution of Items can be tracked as they spread from user device to user device in an organic fashion
The data available in the ShopChat ecosystem (e.g. relating to Items and interactions with those items) can be comprehensively analysed. Information relating to a particular ShopChat Item and its evolution history can be extracted to provide a life history of that item. Data mining of these life histories can provide commercially significant statistical information about user habits, locations and social shopping profiles, as well as allowing sophisticated approaches to monetisation.

It will be understood that the present invention has been described above purely by way of example, and modification of detail can be made within the scope of the invention.

What is claimed is:

1. A method of communicating information relating to product or service offerings between a server system and client devices, the method comprising, at the server system:
storing in a database a plurality of data objects, each data object comprising information relating to a product or service offering; wherein the data objects are associated with corresponding data objects stored at client devices;
receiving information specifying an action relating to a selected data object;
identifying based on information in the database one or more descendant data objects associated with the selected data object, the descendant data object having been derived from the selected data object; and
transmitting information specifying the action to a client device associated with each identified descendant data object.

2. A method according to claim 1, further comprising performing the specified action in relation to an identified descendant data object at the associated user device.

3. A method according to claim 1, wherein the action comprises a modification to the data object, and wherein the transmitted information specifies the modification.

4. A method according to claim 3, further comprising modifying a descendant data object at the client device in accordance with the transmitted information.

5. A method according to claim 1, wherein the action comprises addition of information to a data object, the information preferably specifying an offer or promotion relating to the product or service offering represented by the data object.

6. A method according to claim 1, further comprising identifying a user associated with an identified descendant data object, wherein the information is transmitted to one or more user devices associated with the identified user.

7. A method according to claim 1, wherein the database specifies derivation relationships between data objects, a derivation relationship indicating that a given data object has been derived from another data object, wherein the identifying is performed based on the derivation relationships.

8. A method according to claim 1, wherein an identified descendant data object is associated with a user having created the descendant data object based on the selected data object, and wherein the information is transmitted to the associated user.

9. A method according to claim 1, comprising receiving copies of data objects stored at client devices, and storing the copies of data objects in the database.

10. A method according to claim 9, comprising receiving derivation information from a client device specifying that a received data object was derived from a further data object, the derived data object created at the client device, and recording a derivation relationship in the database between the received data object and the further data object.

11. A method according to claim 1, further comprising analysing data objects and derivation relationships between data objects, preferably to determine information indicative of evolution and/or spread of data objects and their associated descendant data objects amongst a community of system users.

12. A method according to claim 1, wherein a data object comprising information relating to a product or service offering includes one or more of:
image or video information relating to the product or service offering;
text information relating to the product or service offering;
information specifying a source or availability of the product or service offering;
price information relating to the product or service offering; and
location information relating to the product or service offering.

13. A computer-readable medium comprising a software application for a client device adapted to communicate with a remote server system, the software application configured, when executed on the client device, to perform the steps of:
providing access to a plurality of data objects, each data object comprising information relating to a product or service offering;
receiving a modification relating to a selected first one of the plurality of data objects; and, in response to the received modification:
creating a second data object based on the selected first data object and the received modification;
associating derivation information with at least one of the first and second data objects indicating that the second data object was derived from the first data object; and
transmitting the second data object with the derivation information to the remote server system.

14. A computer-readable medium according to claim 13, wherein the software application is configured to store the plurality of data objects in a database at the client device, and to transmit copies of stored data objects to the server system.

15. A computer-readable medium according to claim 13, wherein the derivation information includes a reference to the first data object, the reference contained in the second data object.

16. A computer-readable medium according to claim 13, wherein the software application is further configured to:
receive information specifying an action or modification relating to a selected one of the data objects from the server system; and
apply the action or modification to the selected data object.

17. A computer-readable medium according to claim 13, wherein the application is further configured to provide a user interface for at least one of:
creating or modifying data objects;
creating derived data objects based on provided data objects;
creating or modifying one or more lists of data objects;
sharing data objects or lists with other users; and
initiating a communication exchange with one or more users, the communication exchange associated with a selected data object.

18. A system for tracking exchange of information relating to product or service offerings between system users, comprising:
a database module configured to store a plurality of data objects, each data object comprising information relating to a product or service offering; wherein the data objects are associated with corresponding data objects stored at client devices;
wherein the database module is configured, for a selected data object in the database, to store one or more descendant data objects of the selected data object in the database, the descendant data objects created based on the selected data object at one or more user devices, and to store information specifying derivation relationships, the derivation relationships specifying that the descendant data objects were derived from the selected data object;
and wherein the system further comprises an analysis module adapted to analyse data objects and derivation relationships in the database.

19. A method according to claim 18, wherein the analysis module is adapted to perform at least one of:
identifying, for a given data object, users associated with the given data object or with descendant data objects of the given data object;
measuring or analysing the evolution and/or spread of a given data object and its associated descendant objects between system users; and
measuring or analysing user interactions relating to a given data object and its associated descendant data objects.

20. A method according to claim 18, wherein the client devices are configured to transmit information to the system, the information including at least one of:
information relating to data objects created or stored at the client devices; and
information relating to interactions with data objects at the client devices.

21. A method according to claim 18, wherein client devices are configured to transmit user interaction information relating to data objects to the server system based on one or more configurable user interaction triggers.

22. A method according to claim 18, wherein the analysis module is configured to analyse user interaction information relating to user interactions with one or more specified data objects and their associated descendant data objects.
